(19) United States
(12) Patent Application Publication
(10) Pub. No.: US 2024/0117860 A1
(43) Pub. Date: Apr. 11, 2024

(54) ROPE ASSEMBLIES

(71) Applicant: ADVANCED INNERGY LTD, Gloucester Gloucestershire (GB)

(72) Inventor: Gregory Stanley VAN HINSBERGH, Gloucester Gloucestershire (GB)

(21) Appl. No.: 18/276,404

(22) PCT Filed: Feb. 8, 2022
(86) PCT No.: PCT/GB2022/050319

§ 371 Date: Aug. 8, 2023

(30) Foreign Application Priority Data
Feb. 9, 2021 (GB) 2101776.9

(51) Int. Cl. F16G 11/02; D07B 1/02; D07B 1/14; D07B 1/18; D07B 5/00

(52) U.S. Cl. CPC F16G 11/025; D07B 1/025; D07B 1/14; D07B 1/185; D07B 5/006; D07B 2201/2009; D07B 2201/2044; D07B 2205/201; D07B 2205/205

(57) ABSTRACT

A rope assembly comprises a rope, wherein the rope comprises a plurality of braided or twisted strands. The rope assembly also comprises an attachment structure formed of a polymer. The attachment structure defines an opening through the rope between the strands. The strands are fixedly held in the attachment structure by being encased within the polymer.

### TECHNOLOGICAL FIELD

Examples of the disclosure relate to rope assemblies, and particularly to rope assemblies comprising an attachment structure.

### BACKGROUND

Rope assemblies are known. Rope assemblies permit an article or articles to be attached to a rope using an attachment structure formed on or in the rope. However, in known assemblies the provision of an attachment structure in or on a rope significantly reduces the load the rope assembly can bear. Accordingly, there is a requirement to provide rope assemblies comprising an attachment structure with an improved load bearing capability.

### BRIEF SUMMARY

According to various, but not necessarily all, examples of the disclosure there is provided a rope assembly, the rope assembly comprising:
a rope, wherein the rope comprises a plurality of braided or twisted strands; and
an attachment structure formed of a polymer, wherein the attachment structure defines an opening through the rope between the strands, wherein the strands are fixedly held in the attachment structure by being encased within the polymer.

Possibly, the attachment structure comprises first and second tapered sleeves, wherein the first tapered sleeve tapers to the rope on one side of the attachment structure, and wherein the second tapered sleeve tapers to the rope on the other side of the attachment structure.

Possibly, an equal number of strands are fixedly held in the attachment structure on either side of the opening.

The rope assembly may comprise a plurality attachment structures. The plurality attachment structures may be uniformly spaced apart.

Possibly, the polymer is the cured reaction product of a two-part casting resin, wherein the first part comprises a resin and the second part comprises a hardener. The polymer may be an epoxy polymer or a polyurethane polymer.

The attachment structure may define a circular opening or an elongate opening. The diameter of the opening may be greater than the diameter of the rope.

Possibly, at least the strands of the rope fixedly held in the attachment structure by being encased within the polymer comprise an adhesive coating compatible with the polymer. Possibly, at least the strands of the rope fixedly held in the attachment structure by being encased within the polymer comprise an insulative coating.

The rope may be a high-modulus polyethylene (HMPE) rope, ultra high modulus polyethylene (UHMPE), or aramid co-polymer.

Possibly, the ratio of the diameter of the opening to the diameter of the rope is from 1:10 to 2.5:1, and preferably from 1:2 to 2.5:1, and most preferably from 1.5:1 to 2.5:1.

According to various, but not necessarily all, examples of the disclosure there is provided a method of manufacturing a rope assembly, wherein the method comprises:
forming an opening through a rope between the strands of the rope;
inserting an elongate member through the opening;
assembling a mould around the elongate member;
providing a casting resin in the mould;
allowing the casting resin to cure; and
removing the mould to provide an attachment structure formed of the cured polymer, wherein the attachment structure defines an opening through the rope between the strands, wherein the strands are fixedly held in the attachment structure by being encased within the cured polymer.

Possibly, the method comprises:
applying tension to the rope before forming the opening through the rope between the strands of the rope; and
releasing tension from the rope only after the casting resin has cured.

Possibly, the method comprises:
providing a sleeve on the elongate member, the sleeve being formed of a polymer; and
inserting the elongate member through the opening between the strands of the rope such that the at least some of the strands contact the sleeve, wherein after the casting resin has cured the sleeve is comprised in the attachment structure.

The sleeve may be formed of the same polymer as the polymer of the attachment structure. The contact surfaces of the sleeve may be serrated or wavy to increase the contact surface area and consequently its shear load capability between the rope strands, resin and sleeve.

According to various, but not necessarily all, examples of the disclosure there may be provided examples as claimed in the appended claims.

### BRIEF DESCRIPTION

For a better understanding of various examples that are useful for understanding the detailed description, reference will now be made by way of example only to the accompanying drawings in which:

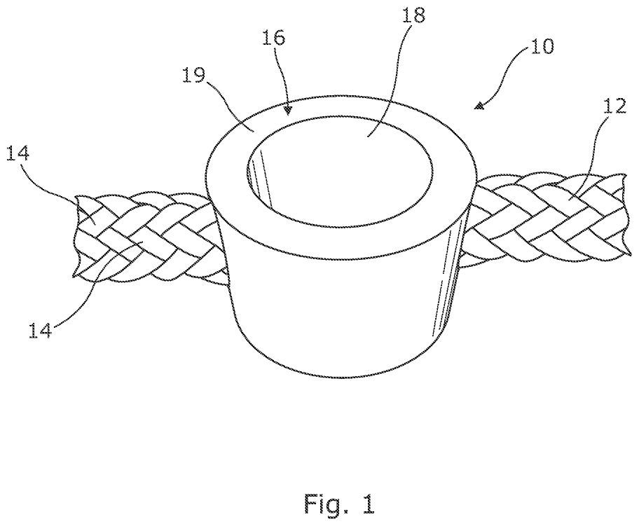

FIG. 1 illustrates a perspective view of a first rope assembly;

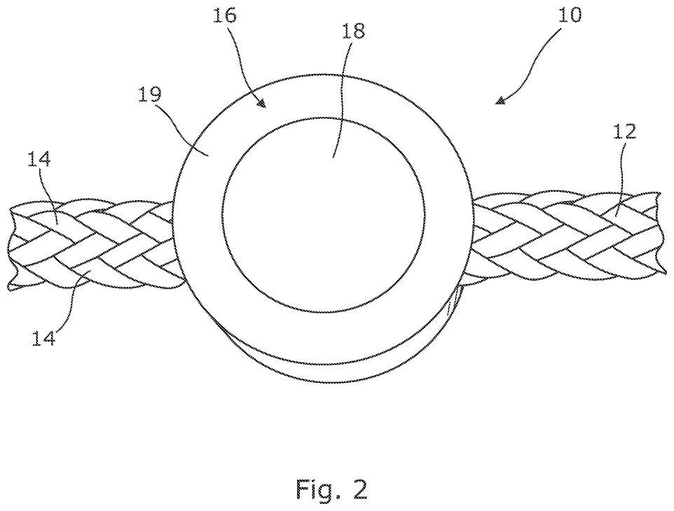

FIG. 2 illustrates a side view of the rope assembly of FIG. 1;

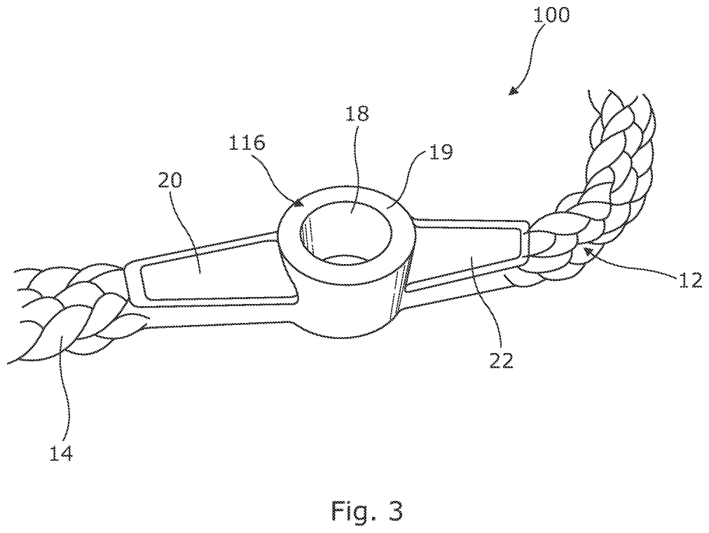

FIG. 3 illustrates a perspective view of a second rope assembly;

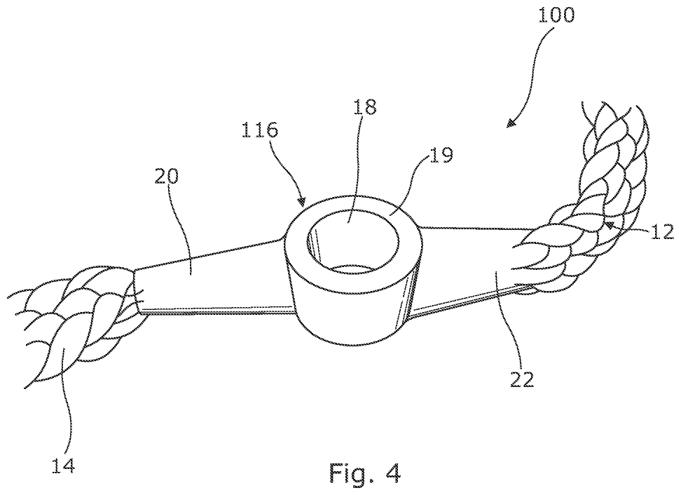

FIG. 4 illustrates another perspective view of the second rope assembly of FIG. 3;

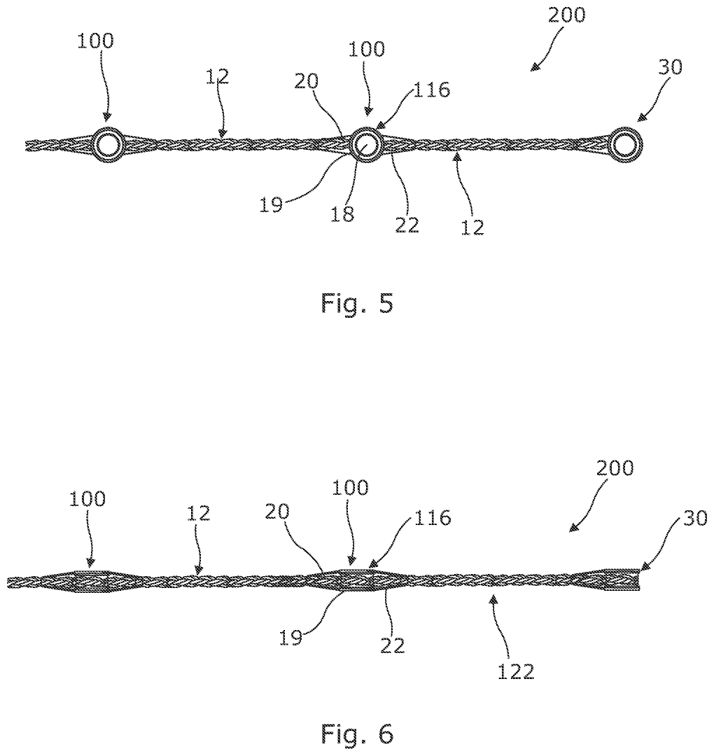

FIG. 5 illustrates a top view of a third rope assembly;

FIG. 6 illustrates a side view of the rope assembly of FIG. 5;

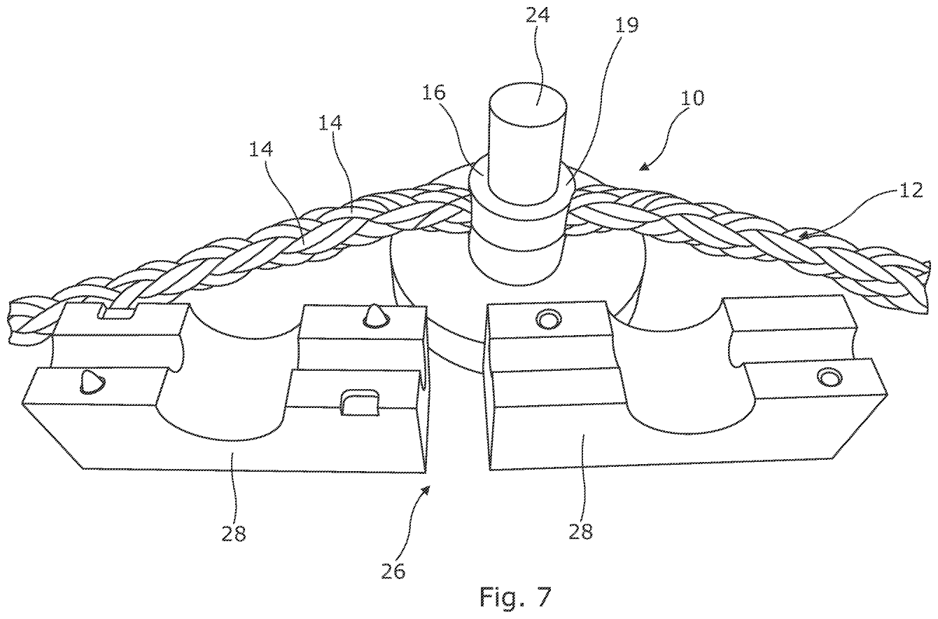

FIG. 7 illustrates the moulding apparatus for forming the rope assembly of FIG. 1, along with the rope assembly of FIG. 1;

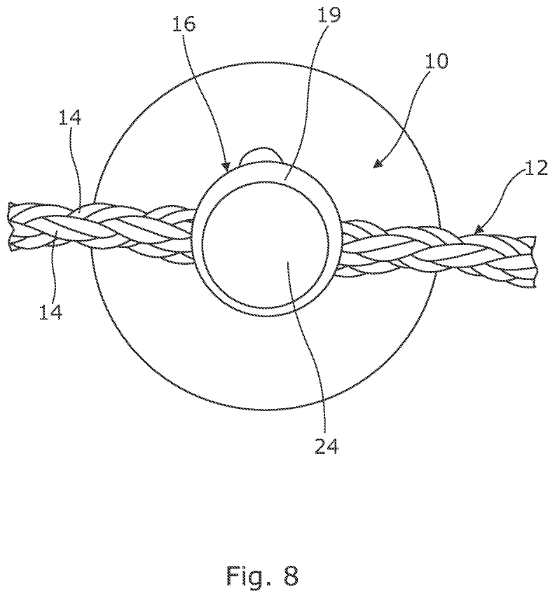

FIG. 8 illustrates a part of the moulding apparatus of FIG. 7;

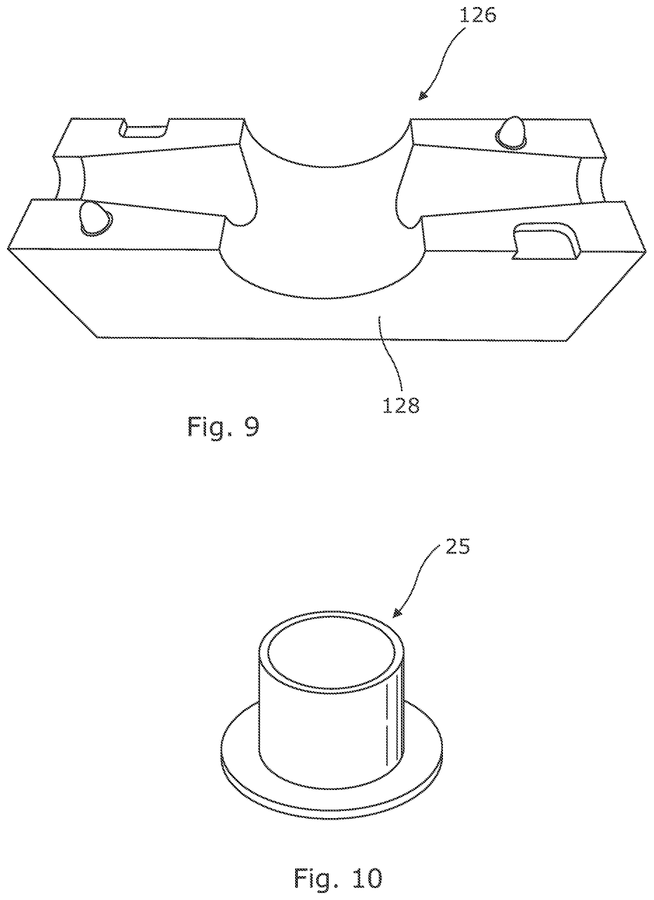

FIG. 9 illustrates a part of the moulding apparatus for forming the rope assembly of FIG. 3; and

FIG. 10 illustrates a part of a rope assembly according to examples of the disclosure.

### DETAILED DESCRIPTION

The figures illustrate a rope assembly 10, 100, 200. Example applications of the rope assembly 10, 200, 200 include, but are not limited to: mooring ropes, tag lines, tethers, fishing nets, and rope ladders.

A first rope assembly 10 is illustrated in FIGS. 1 and 2. The first rope assembly 10 comprises a rope 12. The rope 12 comprises a plurality of braided or twisted strands 14. The rope assembly 10 also comprises an attachment structure 16 formed of a polymer. The attachment structure 16 defines an opening 18 through the rope 12 between the strands 14. A body 19 of the attachment structure 16 defines the opening 18. The body 19 of the attachment structure 16 may be substantially ring shaped.

The opening 18 is configured to receive a structural member (not illustrated) such as a pin from another article to be attached to the rope 12. When a load is applied to the rope, i.e., when the rope 12 is under tension, at least some of the load is transferred to the structural member extending through the opening 18. Accordingly, examples of the disclosure provide a through rope 12 connection point.

The strands 14 are fixedly held in the attachment structure 16 by being encased within the polymer. Accordingly, the strands 14 are set in the polymer.

The attachment structure 16 has a polymer construction. The attachment structure 16 is a unitary casting. The attachment structure 16 is a solid structure. There are no air gaps in the attachment structure 16. The attachment structure 16 provides an integral compartment. The attachment structure 16 may be formed by injection moulding as described below. The attachment structure 16 may be referred to as an eyelet.

In examples of the disclosure, the fibres of the strands 14 of rope 12 fixedly held in the in the attachment structure 16 by being encased within the polymer are impregnated by the casting resin used to form the polymer. Accordingly, the fibres of the strands 14 are intimately associated with the polymer in a composite structure. This increases the shear strength of the polymer by distributing the load applied to the rope 12. The strands 14 of rope 12 encased in the polymer may have an irregular distribution within the polymer.

An equal number of strands 14 are fixedly held in the attachment structure 16 on either side of the opening 18.

In some examples, the attachment structure 16 defines a circular opening 18 for receiving a cylindrical structural member from another article. Such a construction is particularly simple and inexpensive to manufacture. In other examples, the attachment structure 16 defines an elongate opening 18, i.e., a slot. The elongate opening 18 may have two rounded shorter sides and two substantially straight longer sides. The attachment structure 16 may define an opening having any other suitable shape, for instance, oval-shaped. In some examples, a fixing (not illustrated) such as a karabiner may be provided in the opening 18 so that more than one structural member from another article or from different articles may be received in the opening 18.

The diameter of the rope 12 depends on the particular application of the rope assembly 10. For example, a cord for a venetian blind may have a rope diameter of 1 mm, whereas a mooring rope used on an offshore rig may have a rope diameter of 150 mm. Accordingly, examples of the disclosure have wide-ranging applications.

In some examples, the diameter of the opening 18 may be greater than the diameter of the rope 12. For instance, the rope 12 may have a diameter of 14 mm and the opening 18 through the rope 12 between the strands 14 may have a diameter of 30 mm. In other examples, the diameter of the opening 18 may be less than the diameter of the rope 12. For instance, the rope 12 may have a diameter of 40 mm and the opening 18 through the 12 rope between the strands 14 may have a diameter of 4 mm.

The ratio of the diameter of the opening 18 to the diameter of the rope 12 is from 1:10 to 2.5:1, and preferably from 1:2 to 2.5:1, and most preferably from 1.5:1 to 2.5:1. The ratio of the diameter of the opening 18 to the diameter of the rope 12 effects stiffness. Optimally the diameter of the opening 18 is as small as possible relative to the diameter of the rope 12 for a given application so that the load path through the rope 12 is as straight as possible.

The pitch of the rope 12 is dependent on the diameter, i.e., thickness of the rope 12 comprised in the rope assembly 10. In some applications, the pitch of the rope 12 may be about 400 mm to 500 mm. In other applications, for example a rope ladder, the pitch may be from 150 mm to 300 mm.

In some examples, the polymer is the cured reaction product of a two-part casting resin. The first part comprises a resin and the second part comprises a hardener. The casting resin hardens after mixing the first and second parts through a chemical reaction. Accordingly, the attachment structure 16 is the cured reaction product of the selected casting resin.

The casting resin may be combined with various additives as well as filling materials or colorants to provide the desired properties in the cured polymer. An inhibitor can be added to the casting resin to increase the so-called pot life, i.e., the processing time. In some examples, colour pigments and fluorescent dyes may be added to provide a specific required colour. Fillers may be included to influence properties such as mechanical strength, stiffness, or surface hardness. Examples of fillers are, among others, cotton flocks, glass fibres, mineral fillers, and lightweight fillers.

In some examples, the attachment structure 16 is formed from a low exotherm two-pack epoxy, for example epoxy 9483 from Loctite®. The resin of the two-pack epoxy is epoxy and the hardener is an amine. The ratio of epoxy to amine may be 2:1. Accordingly, in such examples the cured polymer of the attachment structure 16 is an epoxy polymer

In other examples, the polymer is formed from a polyurethane two-pack casting resin, which may comprise a polyacrylic resin and a polyisocyanate hardener that react by a polyaddition reaction. Accordingly, in such examples the cured polymer of the attachment structure 16 is a polyurethane polymer.

In some examples, the two-pack casting resin cures at room temperature, for example 22° C. In some examples, an elevated curing temperature may be used, for instance, up to 60° C. The cure time may be from 5 minutes to 2 hours depending on the ratio of resin to hardener and the cure temperature.

In some examples, an elevated curing temperature may be used, for instance, above 60° C. Elevated temperatures may result in greater impregnation of the casting resin into the fibres of the strands 14 of rope 12, thus improving adhesion between the strands 14 and polymer.

The viscosity of the resin is selected to allow a degree of penetration of resin into the fibres of the rope 12. In some examples, the casting resin has a low viscosity, typically 3,000 to 11,000 mPa·s (cP) (Brookfield, 25° C., Spindle 6, speed 20 rpm).

In some examples, the rope 12 is a high-modulus polyethylene (HMPE) rope 12, i.e., Dyneema® rope. HMPE is particularly suitable for subsea use. The rope 12 may though be formed of any material. The selection of rope material depends on the particular application of the rope assembly 10.

In some examples, at least the strands 14 of the rope 12 fixedly held in the attachment structure 16 by being encased within the polymer comprise an adhesive coating compatible with the polymer, i.e., a primer. Such a coating improves adhesion between the strands 14 and polymer. In other examples, alternatively or additionally at least the strands 14 of the rope 12 fixedly held in the attachment structure 16 by being encased within the polymer comprise an insulative coating. The insulative coating reduces heat transfer to the rope 12, for example, caused by the curing of the casting resin (as described below). The insulative coating may comprise, for example, polythene, polyester, or polyurethane. The coating may be spray applied to the rope 12.

A second rope assembly 100 is illustrated in FIGS. 3 and 4. Many features of the second rope assembly 100 are similar to those previously described, and where features are the same or similar the same reference numerals have been used and these features will not be described again for the sake of brevity. In fact, the only differences relative to the first rope assembly 10 already described above are as follows.

The attachment structure 116 of the second rope assembly 100 comprises first and second tapered sleeves 20, 22. The first tapered sleeve 20 tapers to the rope 12 on one side of the attachment structure 116. The second tapered sleeve 22 tapers to the rope 12 on the other side of the attachment structure 116. The respective first and second tapered sleeves 20, 22 taper from the body 19 of the attachment structure 116. The tapered sleeves 20, 22 are in the shape of truncated cones. The tapered sleeves 20, 22 improve the integrity of the rope assembly 100, 200 because the taper gradually reduces stiffness around the opening 18 in the rope assembly 100 which may otherwise cause fatigue issues.

The taper may be between 4 and 15 degrees, i.e., a rise/run ratio of from 1:14 to 1:4.

The attachment structure 116 is a moulded article. Accordingly, the tapered sleeves 20, 22 are integrally formed with the body 19 of the attachment structure 116.

A third rope assembly 200 is illustrated in FIGS. 5 and 6. Many features of the third rope assembly 200 are similar to those previously described, and where features are the same or similar the same reference numerals have been used and these features will not be described again for the sake of brevity. In fact, the only differences relative to the first and second rope assembly 10, 100 already described above are as follows.

The third rope assembly 200 comprises a plurality attachment structures 116. In the illustrated example, the attachment structure 116 of the second rope assembly 100 is provided in the third rope assembly 200. However, in other examples the attachment structure 16 of the first rope assembly 100 may instead be provided. In the illustrated example, the plurality attachment structures 116 are uniformly spaced apart. The spacing between the plurality attachment structures 116 is dependent on the particular application of the rope assembly 200. For example, in a rope ladder application the attachment structures 116 may be provided every 300 mm.

As illustrated in FIGS. 5 and 6, in some examples the rope assembly 200 comprises an end termination 30. In such examples, the rope 12 is woven around a formation such as a thimble and locked in place using a knot, for example a blood knot or equivalent. Alternatively, the rope may be wrapped three time around the formation, which is known to create sufficient friction not to slip. An end termination 30 may be provided even if the rope assembly includes just a single attachment structure 16, 116.

Method

Examples of the disclosure also provided a method of manufacturing rope assemblies 10, 100, 200.

FIGS. 7 to 9 illustrate the moulding apparatus for forming rope assemblies 10, 100, 200 according to examples of the disclosure.

With reference to FIGS. 7 to 9, the method comprises forming an opening (not illustrated) through a rope 12 between the strands 14 of the rope 12 and inserting an elongate member 24 through the opening.

The method comprises assembling a mould 26, 126 around the elongate member 24. The mould 26, 126 comprises a pair of mould casings 28, 128. FIG. 7 illustrates the mould 26 used for forming the first rope assembly 10. FIG. 9 illustrates a one of the pair of mould casings 128 of the mould 126 for forming the second rope assembly 100.

The method comprises providing a casting resin in the mould 26, 126 and allowing the casting resin to cure. The casting resin flows about the strands 14 of the rope 12 impregnating the fibres to an extent. The casting resin may be pumped or injected into the mould 26, 126. The method comprises removing the mould 26, 126 to provide an attachment structure 16, 116 as described above formed of the cured polymer. Accordingly, in some examples the attachment structure 16, 116 is formed by injection moulding. The attachment structure 16, 116 is formed in the mould 26, 126.

To increase the resin density, removal of entrapped air, between the fibres the mould tool can either have a vacuum hose attached diametrically opposed to the resin inlet ports or the entire system can be placed in an autoclave.

In some examples, the method comprises applying tension to the rope 12 before forming the opening through the rope 12 between the strands 14 of the rope 12. The method subsequently comprises releasing tension from the rope 12 only after the casting resin has cured to provide the cured polymer. Applying tension pre strains the rope 12 to provide a required pitch, i.e., pitch length. Subsequently encasing the strands 14 of rope 12 within the cured polymer prevents the required pitch from sliding to a tolerance of less than 1 mm.

In some examples, to apply tension to the rope 12, the rope 12 is weaved around a series of pins with a respective section of rope 12 between each set of adjacent pins. Respective adjacent pins are then selectively moved apart to stretch the respective sections of rope 12 therebetween to create the required rope tension and thus the required pitch. This permits accurate control of rope pitch length.

The strands 14 of the rope 12 are then urged apart at the required location for the attachment structure 16, 116 in the section of rope 12 between adjacent pins using a tapered pin to form the opening through the rope 12 between the strands 14. The tapered pin may be a cone member.

The elongate member 24, which may be in the form of a peg, is then inserted through the opening. The shape and dimensions of the elongate member 24 determine the shape and diameter of the opening 18 in the attachment structure 16, 116.

As described above, a mould 26, 126 is then provided around the elongate member 24. The mould 26, 126 defines the overall shape and dimensions of the attachment structure 16, 116 as described above.

As described above, the casting resin is then pumped into the mould 26, 126 either by injection or gravity and allowed to cure (as described above, resin injection may also be performed under vacuum). The mould is removed once the casting resin has set. Tension is released from the rope assembly 10, 100, 200 by moving adjacent pins back to their original position.

In some examples, the method comprises providing a sleeve 25 on the elongate member 24.

An example sleeve is illustrated in FIG. 10.

The sleeve 25 is formed of a polymer. The sleeve 25 may be formed of the same polymer as the polymer of the attachment structure 16, 116. The method subsequently comprises inserting the elongate member 24 through the opening between the strands 14 of the rope 12 such that at least some of the strands 14 contact the sleeve. After the casting resin has cured the sleeve is comprised in the attachment structure 16, 116. Accordingly, the sleeve 25 is over bonded with the casting resin pumped (or vacuumed) into the mould 26, 126. Accordingly, in such examples the moulding comprises two components. In such examples, the fibres of the strands 14 of rope 12 are spaced from the inside diameter of the opening 18 defined by the attachment structure 16, 116. Advantageously, this prevents snagging or wear of the fibres in use against a structural member which extends through the opening 18 from another article attached to the rope assembly 10, 100, 200.

The sleeve 25 has been illustrated as a plain top hat bush, but it may be injection moulded and have serrated faces which will be over-moulded; to increase the surface area during bonding.

The sleeve 25 keeps the fibres carrying the load away from the outermost surfaces of the resin structure, i.e., the attachment structure 16, 116; which fibres are prone to becoming abraded, for instance, in a marine environment.

An end termination 30 may also be provided with a sleeve 25, as described above in relation to the attachment structure 16, 116.

The method may also comprise spacing apart the strands 14 of rope 12 to avoid or minimize overlap of stands around the opening 18.

The third rope assembly 200 may be manufactured using a plurality of moulds 26, 126 arranged a specific distance apart to provide the required spacing between adjacent attachment structures 16, 116.

In a comparative study a stainless-steel wire rope assembly has a minimum break load of (X), whereas rope assemblies 10, 100, 200 according to examples of the disclosure have been demonstrated to have a minimum break load of (3X). Rope assemblies 10, 100, 200 according to examples of the disclosure may safely bear a load of over 7 tonnes. Accordingly, rope assemblies 10, 100, 200 according to examples of the disclosure have an improved load bearing capability.

There is thus described a rope assembly 10, 100, 200 with a number of advantages as described above.

Furthermore, advantageously the rope assembly 10, 100, 200 is of low mass in air but buoyant subsea, density 0.98, (allowing vessel winches to be significantly smaller. For a long high capacity steel wire rope, as used by the offshore industries a significant proportion of the tension in the winch is generated by the self-mass of the steel wire rope) but has exceptional performance.

Furthermore, advantageously setting the strands 14 of rope 12 within the polymer allows the control of rope pitch length, as described above by fixedly holding the strands 14, i.e., there is no significant migration of rope pitch length (e.g., caused by unwinding of the rope 12) in examples of the disclosure. Furthermore, encasing the strands 14 in the polymer prevents any in use movement of the strands 14 when the rope is held under tension thus increasing the load the rope assembly 10, 100, 200 can safely bear. Such movement would otherwise cause the rope fibres to shear which could result in catastrophic failure.

Furthermore, the rope assembly 10, 100, 200 is corrosion resistant, and for instance, is suitable for use subsea to link together subsea structures. The rope assembly 10, 100, 200 is relatively inexpensive compared to rope assemblies incorporating metallic fasteners, which fasteners may also corrode in use subsea.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

The term “comprise” is used in this document with an inclusive not an exclusive meaning. That is any reference to X comprising Y indicates that X may comprise only one Y or may comprise more than one Y. If it is intended to use “comprise” with an exclusive meaning then it will be made clear in the context by referring to “comprising only one . . . ” or by using “consisting”.

In this brief description, reference has been made to various examples. The description of features or functions in relation to an example indicates that those features or functions are present in that example. The use of the term “example” or “for example” or “may” in the text denotes, whether explicitly stated or not, that such features or functions are present in at least the described example, whether described as an example or not, and that they can be, but are not necessarily, present in some of or all other examples. Thus “example”, “for example” or “may” refers to a particular instance in a class of examples. A property of the instance can be a property of only that instance or a property of the class or a property of a sub-class of the class that includes some but not all of the instances in the class. It is therefore implicitly disclosed that features described with reference to one example but not with reference to another example, can where possible be used in that other example but does not necessarily have to be used in that other example.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A rope assembly, the rope assembly comprising:
a rope, wherein the rope comprises a plurality of braided or twisted strands; and
an attachment structure formed of a polymer, wherein the attachment structure defines an opening through the rope between the strands, wherein the strands are fixedly held in the attachment structure by being encased within the polymer,
wherein at least the strands of the rope, fixedly held in the attachment structure by being encased within the polymer, comprise an insulative coating.

2. The rope assembly according to claim 1, wherein the attachment structure comprises first and second tapered sleeves, wherein the first tapered sleeve tapers to the rope on one side of the attachment structure, and wherein the second tapered sleeve tapers to the rope on the other side of the attachment structure.

3. The rope assembly according to claim 1, wherein an equal number of strands are fixedly held in the attachment structure on either side of the opening.

4. The rope assembly according to claim 1, wherein the rope assembly comprises a plurality of attachment structures.

5. The rope assembly according to claim 4, wherein the plurality of attachment structures are uniformly spaced apart.

6. The rope assembly according to claim 1, wherein the polymer is the cured reaction product of a two-part casting resin, wherein the first part comprises a resin and the second part comprises a hardener.

7. The rope assembly according to claim 1, wherein the polymer is an epoxy polymer or a polyurethane polymer.

8. The rope assembly according to claim 1, wherein the attachment structure defines a circular opening or an elongate opening.

9. The rope assembly according to claim 1, wherein a diameter of the opening is greater than a diameter of the rope.

10. The rope assembly according to claim 1, wherein at least the strands of the rope fixedly held in the attachment structure by being encased within the polymer comprise an adhesive coating compatible with the polymer.

11. The rope assembly according to claim 1, wherein at least the strands of the rope fixedly held in the attachment structure by being encased within the polymer comprise an insulative coating.

12. The rope assembly according to claim 1, wherein the rope is a high-modulus polyethylene (HMPE) rope, ultra high modulus polyethylene (UHMPE) or aramid co-polymer.

13. A method of manufacturing a rope assembly, wherein the method comprises:
forming an opening through a rope between the strands of the rope;
inserting an elongate member through the opening;
assembling a mold around the elongate member;
providing a casting resin in the mold;
allowing the casting resin to cure; and
removing the mold to provide an attachment structure formed of the cured polymer, wherein the attachment structure defines an opening through the rope between the strands, wherein the strands are fixedly held in the attachment structure by being encased within the cured polymer.

14. The method according to claim 13, wherein the method comprises:
applying tension to the rope before forming the opening through the rope between the strands of the rope; and
releasing tension from the rope only after the casting resin has cured.

15. The method according to claim 13, wherein the method comprises:
providing a sleeve on the elongate member, the sleeve being formed of a polymer; and
inserting the elongate member through the opening between the strands of the rope such that at least some of the strands contact the sleeve, wherein after the casting resin has cured the sleeve is comprised in the attachment structure.

16. The method according to claim 15, wherein the sleeve is formed of the same polymer as the polymer of the attachment structure.

17. The method according to claim 15, wherein at least the strands of the rope, fixedly held in the attachment structure by being encased within the cured polymer, comprise an insulative coating

18. The rope assembly according to claim 2, wherein the taper is between 4 and 15 degrees.

19. The rope assembly according to claim 1, wherein a ratio of a diameter of the opening to a diameter of the rope is from 1:10 to 2.5:1.

20. A rope assembly, the rope assembly comprising:
a rope, wherein the rope comprises a plurality of braided or twisted strands; and
an attachment structure formed of a polymer, wherein the attachment structure defines an opening through the rope between the strands, wherein the strands are fixedly held in the attachment structure by being encased within the polymer,
wherein a ratio of a diameter of the opening to a diameter of the rope is from 1:10 to 2.5:1.
